(19) United States
(12) Patent Application Publication
(10) Pub. No.: US 2016/0266440 A1
(43) Pub. Date: Sep. 15, 2016

(54) LAMPSHADE, BACKLIGHT MODULE AND DISPLAY APPARATUS

(71) Applicants: BOE TECHNOLOGY GROUP CO., LTD., Beijing (CN); BEIJING BOE DISPLAY TECHNOLOGY CO., LTD., Beijing (CN)

(72) Inventors: HAI CHI, BEIJING (CN); QING MA, BEIJING (CN); WENJIA SUN, BEIJING (CN)

(73) Assignees: BOE TECHNOLOGY GROUP CO., LTD., Beijing (CN); BEIJING BOE DISPLAY TECHNOLOGY CO., LTD., Beijing (CN)

(21) Appl. No.: 14/408,506

(22) PCT Filed: May 21, 2014
(86) PCT No.: PCT/CN2014/077989

§ 371 Date: Dec. 16, 2014

(30) Foreign Application Priority Data
Dec. 24, 2013 (CN) 201310722370.1

(51) Int. Cl. G02F 1/1335; G02B 27/22

(52) U.S. Cl. CPC G02F 1/133606; G02F 1/133603; G02B 27/2214; G02F 2001/133607

(57) ABSTRACT

The present disclosure discloses a lampshade, a backlight module and a display apparatus. The lampshade includes a containing part and a light-emitting part, wherein a chamber for containing the light source is provided inside the containing part, and a convex ridge projecting outwardly is provided on an outer surface, which is opposite to the containing part, of the light-emitting part, in order to converge light emitted by the light source in the chamber. The backlight module includes an optical film layer and a light source apparatus, wherein the light source apparatus includes a plurality of the lampshades according to the present disclosure. The display apparatus includes the backlight module according to the present disclosure.

### CROSS-REFERENCE TO RELATED APPLICATION

This application is the U.S. national phase of PCT Application No. PCT/CN2014/077989 filed on May 21, 2014, which claims priority to Chinese Patent Application No. 201310722370.1 filed on Dec. 24, 2013, the disclosures of which are incorporated in their entirety by reference herein.

### TECHNICAL FIELD

The present disclosure relates to the field of display technology, in particular to a lampshade, a backlight module and a display apparatus.

### BACKGROUND

A backlight module is one of important components of a liquid crystal display. Since the liquid crystal itself does not emit light, the backlight module is needed to provide sufficient brightness and uniformly-distributed light for the liquid crystal display, so that images can be displayed normally on the liquid crystal display. Currently, the display technology of the liquid crystal display has become mature; especially there has been a great development in design of the backlight module. Besides applied on liquid crystal display apparatuses such as the liquid crystal display, liquid crystal televisions and the like, the backlight module can also provide light source for digital photo frames, electronic papers, mobile phones and other display apparatuses.

The backlight modules are divided into edge-type backlight modules and direct-type backlight modules based on positions of light sources. Many of the direct-type backlight modules use cold cathode fluorescent lamps (CCFLs) as light sources. Though the CCFLs have the price advantage, they will soon not be used any more since they contain toxic mercury vapor.

Solutions of replacing CCFLs with LED light strips have occurred on the market. In the existing LED backlight sources, LEDs are arranged linearly on a light strip substrate. When the linearly arranged backlight sources are applied into a 3D display apparatus, since each of the LEDs has a certain light-emitting angle, light emitted from two adjacent LEDs overlaps to each other due to the existence of the above angle. The overlapped light causes a crosstalk phenomenon, so as to affect the display quality of the display apparatus, and it is particularly prone to generate blur and smearing in high-speed motion pictures.

### SUMMARY

An object of the present disclosure is to provide a lampshade, a backlight module and a display apparatus to avoid the crosstalk phenomenon.

The lampshade according to the present disclosure, includes a containing part configured to contain a light source and a light-emitting part connected to the containing part and configured to emit light, wherein a chamber for containing the light source is provided inside the containing part, and a convex ridge projecting outwardly is provided on an outer surface, which is opposite to the containing part, of the light-emitting part.

Alternatively, a cross section of the convex ridge is a triangle or a trapezoid or an arc.

Alternatively, there are a plurality of the convex ridges which are arranged in parallel on the outer surface of the light-emitting part.

Alternatively, a cross section of the convex ridge is a triangle and the convex ridge includes a first wall and a second wall which are opposite and connected to each other. The first wall and the second wall are symmetric along a longitudinal axis of the top of the convex ridge.

Alternatively, a range of an angle formed by the first wall and second wall is 90 to 180 degree.

Alternatively, the angle formed by the first wall and the second wall is 120 degree.

Alternatively, the chamber includes a first side wall, a second side wall, a third side wall and a fourth side wall which are connected in sequence. An inner surface of the first side wall, an inner surface of the second side wall, an inner surface of the third side wall, and an inner surface of the fourth side wall are provided respectively with a reflection layer for reflecting light emitted by the light source.

The backlight module according to the present disclosure, includes an optical film layer and a light source apparatus provided on a light-entering surface of the optical film layer, wherein, the light source apparatus includes one or more lampshades according to the present disclosure, and a light source provided inside the chamber of the lampshade, light emitted by the light source is emitted to the optical film layer via the light-emitting part of the lampshade.

Alternatively, a plurality of the lampshades are arranged in a line on the light-entering surface of the optical film layer. An arrangement direction of the plurality of the lampshades is the same as an arrangement direction of a plurality of the convex ridges on the lampshades.

Alternatively, the light source is an LED lamp. The light source apparatus further includes a printed circuit board which connects to a plurality of the LED lamps and is provided at a bottom of the plurality of the lampshades.

The display apparatus according to the present disclosure includes the backlight module according to the present disclosure.

The lampshade according to the present disclosure causes the light emitted by a source light to be converged, so that an overlap area between light emitted by the light source and light emitted by adjacent light sources is greatly reduced, thereby to avoid the crosstalk phenomenon.

Because of the use of the lampshade according to the present disclosure, the backlight module according to the present disclosure has a better light emitting effect and the costs are significantly reduced.

Because of the use of the backlight module according to the present disclosure, the product quality of the display apparatus according to the present disclosure is greatly improved.

### BRIEF DESCRIPTION OF THE DRAWINGS

FIG. 1 is a front view showing a structure of a lampshade according to an embodiment of the present disclosure;

FIG. 2 is a perspective view showing a structure of a lampshade according to an embodiment of the present disclosure;

FIG. 3 is a schematic diagram showing a structure of a backlight module according to an embodiment of the present disclosure;

FIG. 4 is a schematic diagram showing a structure of a backlight module according to the related art.

### DETAILED DESCRIPTION

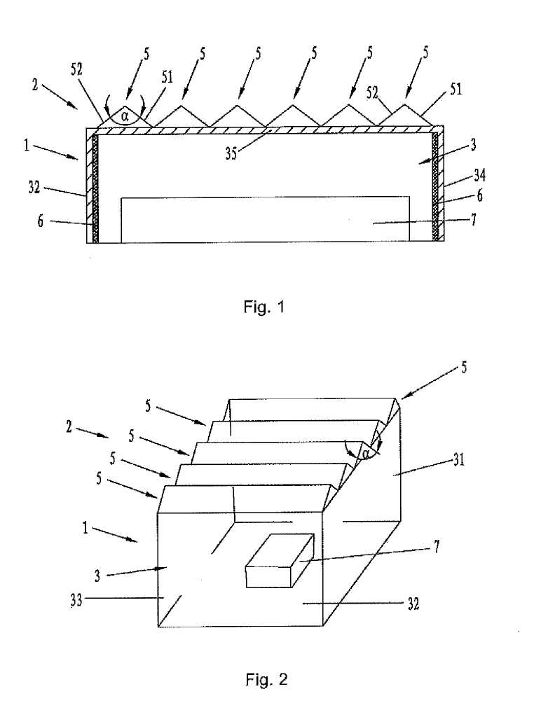

As shown in FIGS. 1 and 2, a lampshade according to an embodiment of the present disclosure includes a containing part 1 configured to contain a light source, and a light-emitting part 2 connected to the containing part 1 and configured to emit light. A chamber 3 configured to contain the light source 7 is provided inside the containing part, and a convex ridge 5 projecting outwardly is provided on an outer surface, which is opposite to the containing part 1, of the light-emitting part 2, to converge light emitted by the light source 7 in the chamber 3.

In the lampshade according to an embodiment of the present disclosure, a cross section of the convex ridge 5 is a triangle.

In the lampshade according to other embodiments, the cross section of the convex ridge 5 may be a trapezoid or an arc. Based on refraction effect of a triangular prism, the convex ridge 5 in the lampshade according to the present disclosure, of which the cross section is a triangle and the shape is similar to a triangular prism, may also be able to refract and collect light (especially light emitted from a bottom surface), i.e., to converge the light emitted by the light source 7 in the chamber 3. Similarly, when the cross section of the convex ridge 5 is a trapezoid or an arc, the convex ridge 5 may also be able to converge the light emitted by the light source 7 in the chamber 3.

In the lampshade according to an embodiment of the present disclosure, there are a plurality of convex ridges 5 which are arranged in parallel on the outer surface of the light-emitting part 2.

When the lampshade is working, the light source 7 is located inside the chamber 3. Light emitted by the light source 7 is transmitted to a bottom of the convex ridge 5. Then the light is converged and scattered outwardly under the refraction effect of two side walls of the convex ridge 5.

In the lampshade, the convex ridge 5 includes a first wall 51 and a second wall 52 which are opposite and connected to each other and symmetric along a longitudinal axis of the top of the convex ridge 5.

In the lampshade, an angle range of an angle a formed by the first wall 51 and second wall 52 is 90 to 180 degree.

In the lampshade, the angle a formed by the first wall 51 and the second wall 52 is 120 degree.

In the lampshade, the chamber 3 includes a first side wall 31, a second side wall 32, a third side wall 33 and a fourth side wall 34 which are connected in sequence. The chamber 3 further includes a top wall 35 disposed above the first side wall 31, the second side wall 32, the third side wall 33 and the fourth side wall 34. The light-emitting part 2 is provided on the top wall 35. An inner surface of the first side wall 31, an inner surface of the second side wall 32, an inner surface of the third side wall 33, and an inner surface of the fourth side wall 34 are provided respectively with a reflection layer 6 for reflecting the light emitted by the light source 7. The reflection layer 6 causes the light, which is emitted by the light source 7 to the side wall, to be reflected inside the chamber 3, then only to be emitted out from the light-emitting part 2 on the top of the chamber 3, but not to be emitted out from the side wall of the chamber 3, thereby further reducing a divergence angle of the light source 7.

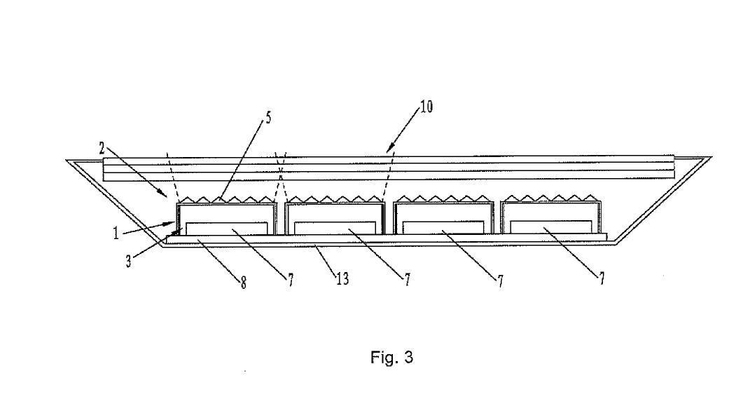

As shown in FIG. 3, a backlight module according to an embodiment of the present disclosure includes an optical film layer 10, a light source apparatus provided on a light-entering surface of the optical film layer 10 and a back plate 13. The light source apparatus is provided between the optical film layer 10 and the back plate 13. The light source apparatus includes one or more lampshades and a light source 7 provided inside the chamber 3 of the lampshade. The top of the lampshade points to the light-entering surface of the optical film layer 10. The light emitted by the light source 7 is emitted to the optical film layer 10 via the light-emitting part 2 of the lampshade.

In the backlight module, a plurality of the lampshades are arranged in a line on the light-entering surface of the optical film layer 10. An arrangement direction of the plurality of the lampshades is the same as an arrangement direction of the plurality of the convex ridges 5 on the lampshades.

In the backlight module, the light source 7 is an LED lamp. The light source apparatus further includes a printed circuit board 8 which connects a plurality of LED lamps and is provided at bottoms of the plurality of the lampshades.

When the backlight module is in use, the light emitted by light source 7 is transmitted to the bottom of the convex ridge 5. And, under the refraction effect of two side walls of the convex ridge 5, the light is converged and scattered outwardly through the optical film layer 10.

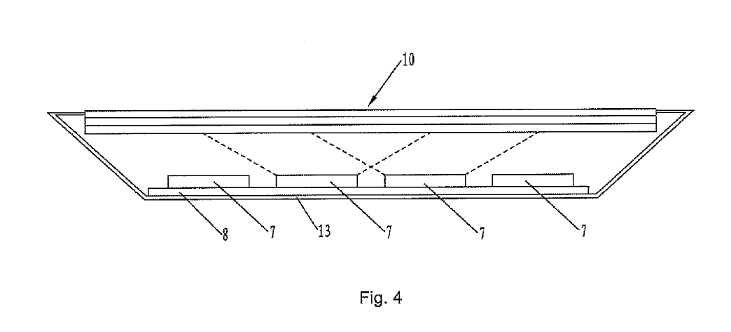

As shown in FIG. 4, in a backlight module of the related art, the lampshade according to the present disclosure is not used, and the printed circuit board 8 is provided on the back plate 13. The light source 7 on the printed circuit board 8 directly faces the optical film layer 10, therefore, light emitted by the light source 7 is not converged, and the light emitting angle thereof may generally be up to 120 degree. In this case, there is an overlap between light emitted by the light source and light emitted by adjacent light sources, and the overlapped light can easily lead to the crosstalk phenomenon.

However, in the backlight module according to the present disclosure, the lampshade according to the present disclosure makes the light emitted by the source light 7 be converged. A divergence angle of the light transmitted out through the lampshade is greatly reduced, so that an overlap area between light emitted by the light source and light emitted by adjacent light sources is greatly reduced. When such a backlight source is applied in a 3D display apparatus, the crosstalk phenomenon can be avoided.

A display apparatus according to the present disclosure includes the backlight module according to the present disclosure. The display apparatus may be any product or component having a display function such as liquid crystal panels, electronic papers, liquid crystal televisions, liquid crystal displays, digital photo frames, mobile phones, tablet computers and the like.

The above are only preferred embodiments of the present disclosure, it should be noted that, many improvements and modifications may be made for a person skilled in the art without departing from the principles of the present disclosure, and should also be considered as falling within the protection scope of the present disclosure.

What is claimed is:

1. A lampshade, comprising a containing part configured to contain a light source and a light-emitting part connected to the containing part and configured to emit light, wherein a chamber for containing the light source is provided inside the containing part, and a convex ridge projecting outwardly is provided on an outer surface, which is opposite to the containing part, of the light-emitting part.

2. The lampshade according to claim 1, wherein a cross section of the convex ridge is a triangle or a trapezoid or an arc.

3. The lampshade according to claim 1, wherein there are a plurality of the convex ridges which are arranged in parallel on the outer surface of the light-emitting part.

4. The lampshade according to claim 2, wherein there are a plurality of the convex ridges which are arranged in parallel on the outer surface of the light-emitting part.

5. The lampshade according to claim 1, wherein a cross section of the convex ridge is a triangle and the convex ridge comprises a first wall and a second wall which are opposite and connected to each other.

6. The lampshade according to claim 5, wherein the first wall and the second wall are symmetric along a longitudinal axis of the top of the convex ridge.

7. The lampshade according to claim 5, wherein a range of an angle formed by the first wall and second wall is 90 to 180 degree.

8. The lampshade according to claim 6, wherein a range of an angle formed by the first wall and second wall is 90 to 180 degree.

9. The lampshade according to claim 7, wherein the angle formed by the first wall and the second wall is 120 degree.

10. The lampshade according to claim 1, wherein the chamber comprises a first side wall, a second side wall, a third side wall and a fourth side wall 34 which are connected in sequence.

11. The lampshade according to claim 10, wherein an inner surface of the first side wall, an inner surface of the second side wall, an inner surface of the third side wall, and an inner surface of the fourth side wall are provided respectively with a reflection layer for reflecting light emitted by the light source.

12. A backlight module, comprising an optical film layer and a light source apparatus provided on a light-entering surface of the optical film layer, wherein, the light source apparatus comprises one or more lampshades according to claim 1, and the light source provided inside the chamber of the lampshade, light emitted by the light source is emitted to the optical film layer via the light-emitting part of the lampshade.

13. The backlight module according to claim 12, wherein a plurality of the lampshades are arranged in a line on the light-entering surface of the optical film layer.

14. The backlight module according to claim 13, wherein an arrangement direction of the plurality of the lampshades is the same as an arrangement direction of a plurality of the convex ridges on the lampshades.

15. The backlight module according to claim 12, wherein the light source is an LED lamp.

16. The backlight module according to claim 12, wherein the light source apparatus further comprises a printed circuit board which connects to a plurality of LED lamps and is provided at a bottom of the plurality of the lampshades.

17. A display apparatus, comprising the backlight module according to claim 12.

18. The display apparatus according to claim 17, wherein a plurality of the lampshades are arranged in a line on the light-entering surface of the optical film layer.

19. The display apparatus according to claim 18, wherein an arrangement direction of the plurality of the lampshades is the same as an arrangement direction of a plurality of the convex ridges on the lampshades.

20. The display apparatus according to claim 17, wherein the light source is an LED lamp.
